(19) United States
(12) Patent Application Publication
(10) Pub. No.: US 2018/0146825 A1
(43) Pub. Date: May 31, 2018

(54) BARBECUE OVEN

(71) Applicant: HANGZHOU ZHIHONG IMPORT AND EXPORT CORP. LTD., Zhejiang (CN)

(72) Inventor: Xudong Qian, Zhejiang (CN)

(21) Appl. No.: 15/703,720

(22) Filed: Sep. 13, 2017

(30) Foreign Application Priority Data
Nov. 28, 2016 (CN) 2016110673134

(51) Int. Cl. A47J 37/07; A47J 37/06

(52) U.S. Cl. CPC A47J 37/0786; A47J 37/0647

(57) ABSTRACT

An barbecue oven, comprising a frame body, an oven shell, a burner, fire plates and grilling nets; a protrusion is arranged at the middle part of the fire plate and each side of the protrusion is provided with a plurality of upheavals, and at the side of the upheavals close to the left and right edges of the fire plates heat emission holes are cut; the grilling net comprises a plurality of grilling strips which are inverted U-shaped metal sheet and a plurality of connecting strips. The grilling strips are connected by the connecting strips.

### CROSS REFERENCE TO RELATED APPLICATION

The present application claims the priority of Chinese Patent Application NO. 201611067313.4, filed on Nov. 28, 2016, the disclosure of which is incorporated by reference herein in its entirety.

### TECHNICAL FIELD

The application relates to a barbecue oven.

### BACKGROUND

Barbecue foods are very popular with people, especially the younger generation because of its unique and wonderful taste. Gas-fired oven is now a kind of widespread barbecue oven as it is easy to use, low pollution and clean. The existing gas-fired oven structure generally has a gas pipe inside the furnace body, above the gas pipe fire plates are arranged and above the fire plates a net or a bakeware is arranged. The fire plates mainly serve to gather heat, increase the temperature below the grilling net, prevent the rapid dissemination of heat, and further prevent the grease or residue of food from falling and burning or bursting after a direct contact with the fire, and finally improve the safety of the barbecue process. As shown in FIG. 12, the structure of existing fire plates is substantially a board rising upwardly and with a longitudinal cross-section close to the arc shape, and on which small holes or slits are cut to have the heat dissipating slowly. Yet in such barbecue oven, the temperature of the position above the gap between each two adjacent fire plates differs greatly from that of the position above the fire plate, resulting in uneven temperature below the net and low thermal efficiency. At the same time, the existing grilling net is mostly made of solid metal wire by welding, with simple structure and easy processing, and easy to clean. But in the course of barbecue, foods placed on the net are heated and grilled at large by the heat passing through the gap between round metal bars, and the net is only used to hold foods and placed above the fire plates. During the barbecue, the temperature of the round metal bar is relatively high, and some of the foods in contact with the round metal bar is scorched, affecting the quality and taste of the food. The bakeware usually is of an ordinary cast iron baking sheet with great thickness, so the slow increase of temperature wastes a lot of heat.

### SUMMARY

The technical problem to be solved by the present application is to overcome the above-mentioned deficiencies of the prior art, and to provide an barbecue oven with simple structure, easy use, high thermal efficiency and uniform temperature below the grilling net and able to frying and grilling foods with the grilling net.

The barbecue oven provided by the application employs the technical proposal below: the barbecue oven comprises a frame body, an oven shell arranged on the frame body, a burner arranged in the oven shell, fire plates arranged above the burner and grilling nets arranged above the fire plates; and the barbecue oven is characterized by that: a protrusion is arranged at the middle part of the fire plate and each side of the protrusion is provided with a plurality of upheavals, and at the side of the upheavals close to the left and right edges of the fire plates heat emission holes are cat; the grilling net comprises a plurality of grilling strips which are inverted U-shaped metal sheet and a plurality of connecting strips. The grilling strips are connected by the connecting strips.

The barbecue oven provided by the application further employs the auxiliary technical proposal as below:

The distance between the grilling net and the fire plates is 50-120 mm.

The upheavals are in the shape of symmetric cambered surface with pointed ends

The rising height of the upheavals gradually increases from the middle of the fire plates to the edge.

The max height of the upheavals is 5-12 mm.

The net distance at the narrowest part between each two adjacent upheavals at the same side of the protrusion is 10-35 mm.

An elevated part is arranged at the bottom end of the inverted U-shaped metal sheet and is connected with the connecting strips.

The height of the elevated part is 1-6 mm.

The grilling strips are arranged orderly and in parallel on the connecting strips and the net distance between each two adjacent grilling strips is 10-14 mm.

The width of the grilling strips is 5-25 mm and the height is 3-15 mm.

The fire plate is provided with holder parts, and the oven shell is provided with a support step, and the holder part is matched with the support step.

Compared with the prior art, the barbecue oven provided by the application has the following advantages: first the arrangement of the upheavals expands the heat dissipation area of the fire plate, thereby improving the heat dissipation efficiency of the fire plate; the heat emission holes cut on one side of the upheavals close to the right and left edges of the fire plates effectively narrow the temperature difference between the position above the gap between each two adjacent fire plates and the position above the fire plate, leading to even heating of food on the grilling net and improved barbecue efficiency, and further, the non-opposite arrangement of the heat emission holes and the grilling net prevents the grease or residues of foods from falling to the position below the fire plates; second, the grilling net of the present application, with simple structure and easy processing technique, is formed by arc plates as the grilling strips, so having a very high thermal efficiency, while reducing the temperature difference between the grilling strips and the gaps between the grilling strips. The grilling net maximizes the thermal efficiency of the present application, makes the food heated more uniformly, has high thermal efficiency and good energy saving, and further prevents the food from being burned if the food in direct contact with the grilling strips and facilitates the grease to fall down and reduce the grease on the grilling strips, and finally, as the food is not easy to stick with the net, it is easy to clean.

### BRIEF DESCRIPTION OF THE DRAWINGS

FIG. 1 is a structural drawing of the barbecue oven of the application with the grilling net separated from the oven shell.

FIG. 2 is a structural drawing of the barbecue oven of the application.

FIG. 3 is a cross-section drawing of the barbecue oven of the application.

FIG. 4 is a structural drawing of the fire plates of the application.

FIG. 5 is a top view of the fire plates of the application.

FIG. 6 is the cross-section drawing of A-A in FIG. 4.

FIG. 7 is a structural drawing (I) of the grilling net of the application,

FIG. 8 is a structural drawing (II) of the grilling net of the application.

FIG. 9 is a top view of the grilling net of the application.

FIG. 10 is a cross-section drawing of B-B in FIG. 9.

FIG. 11 is an enlarged drawing of C in FIG. 10.

FIG. 12 is a structural drawing of the fire plates of prior art.

### DETAILED DESCRIPTION

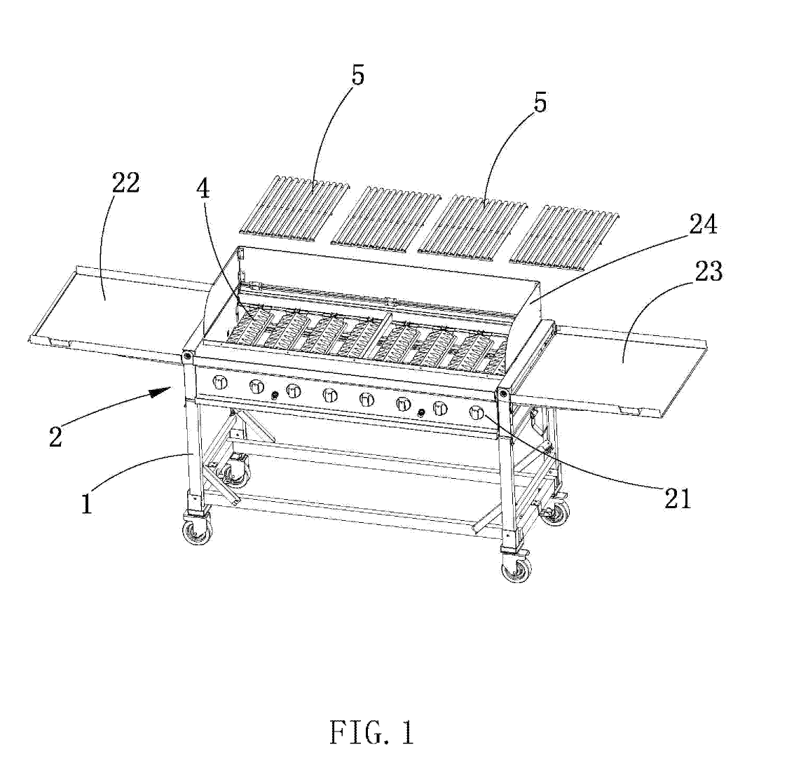

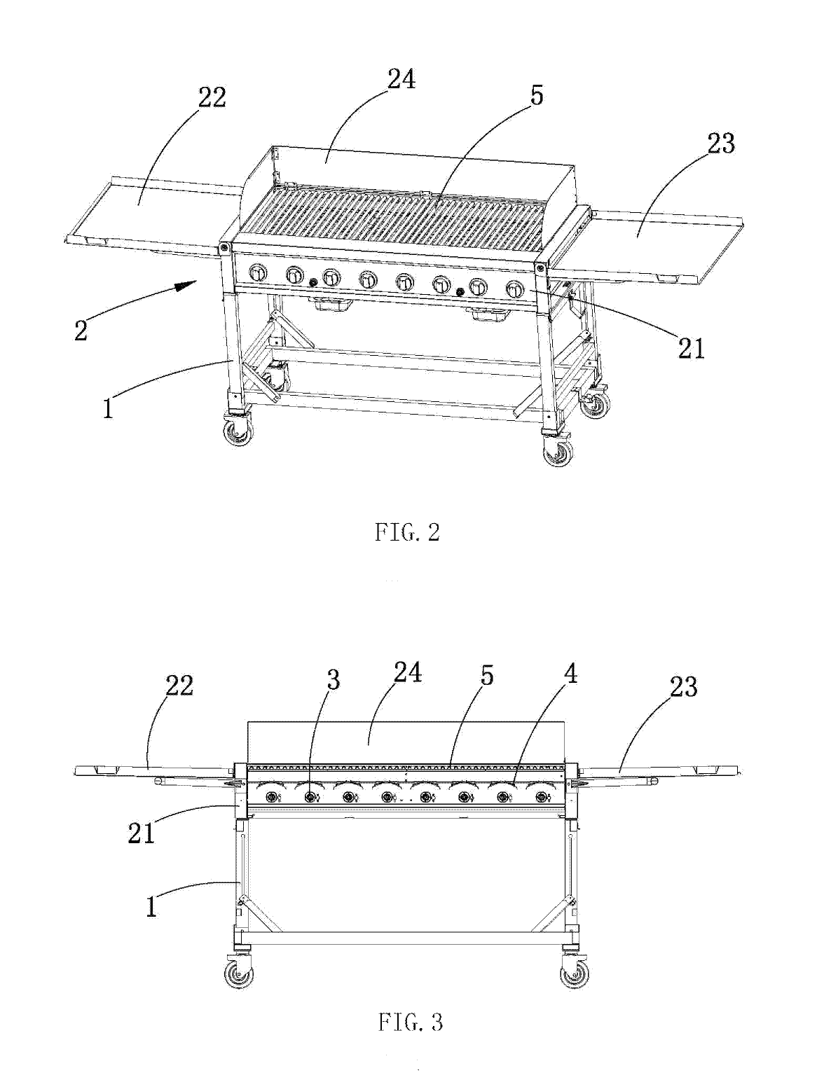

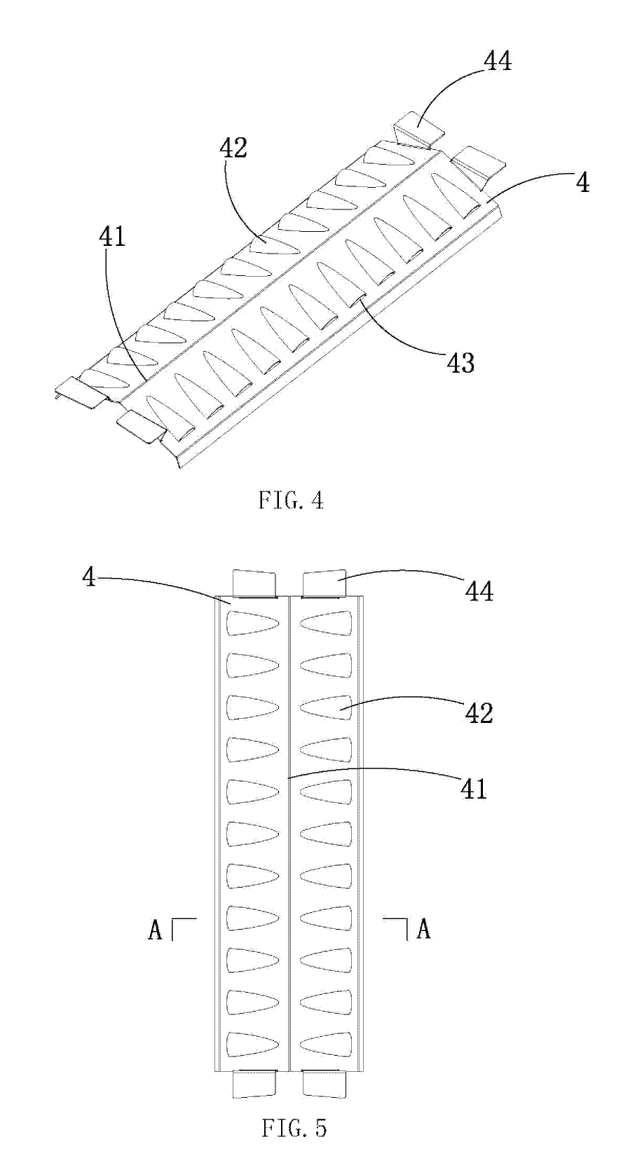

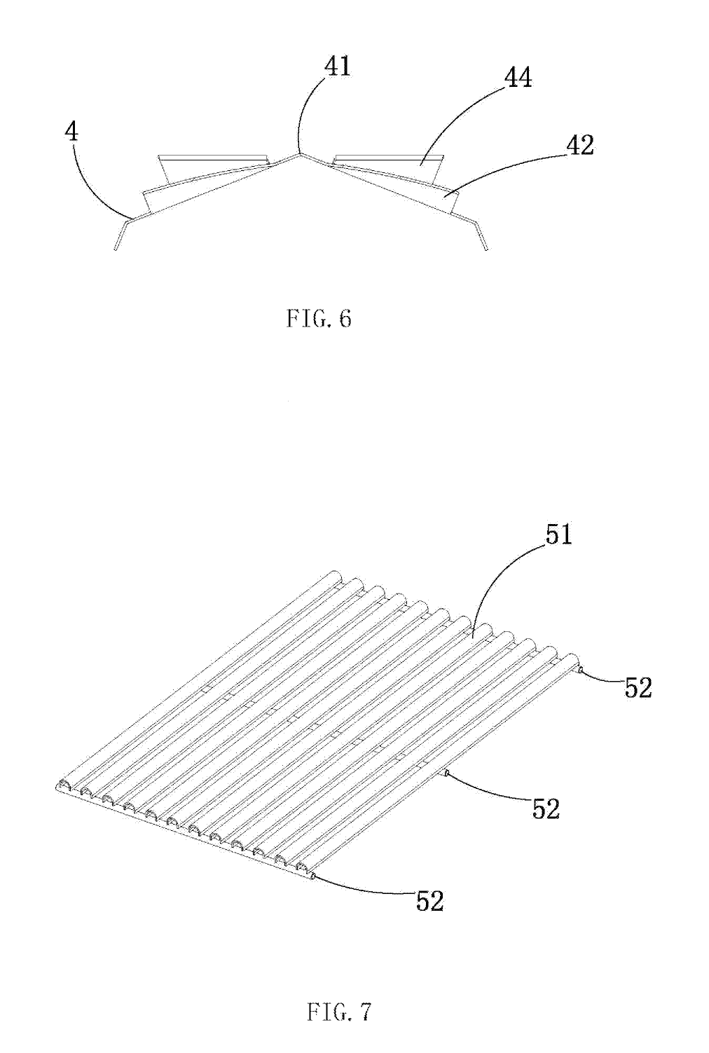

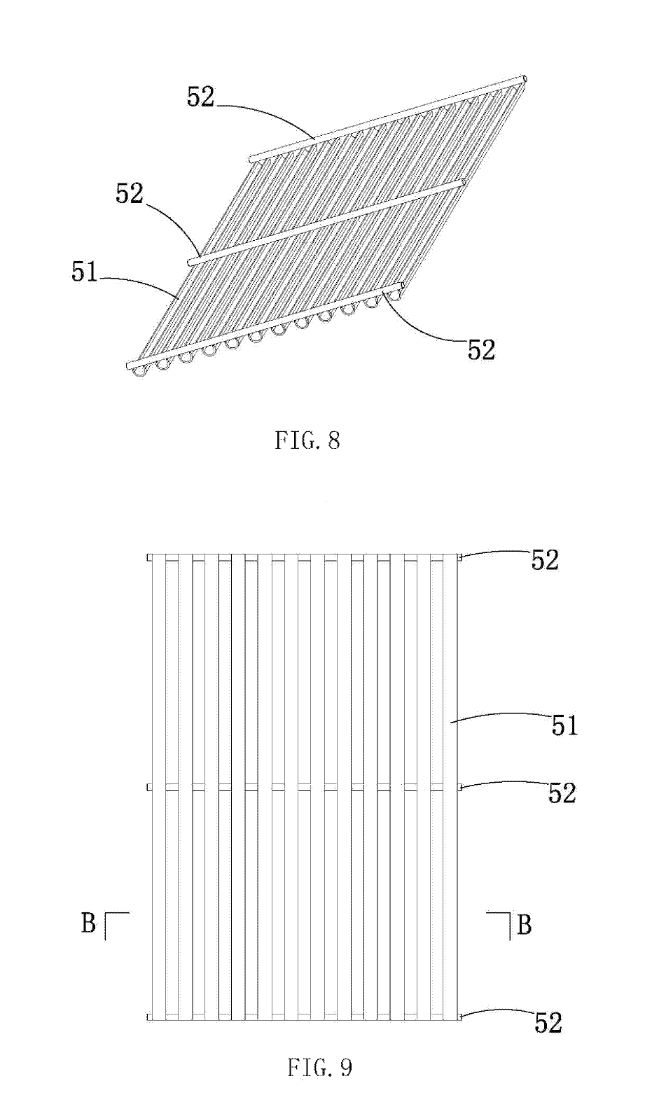

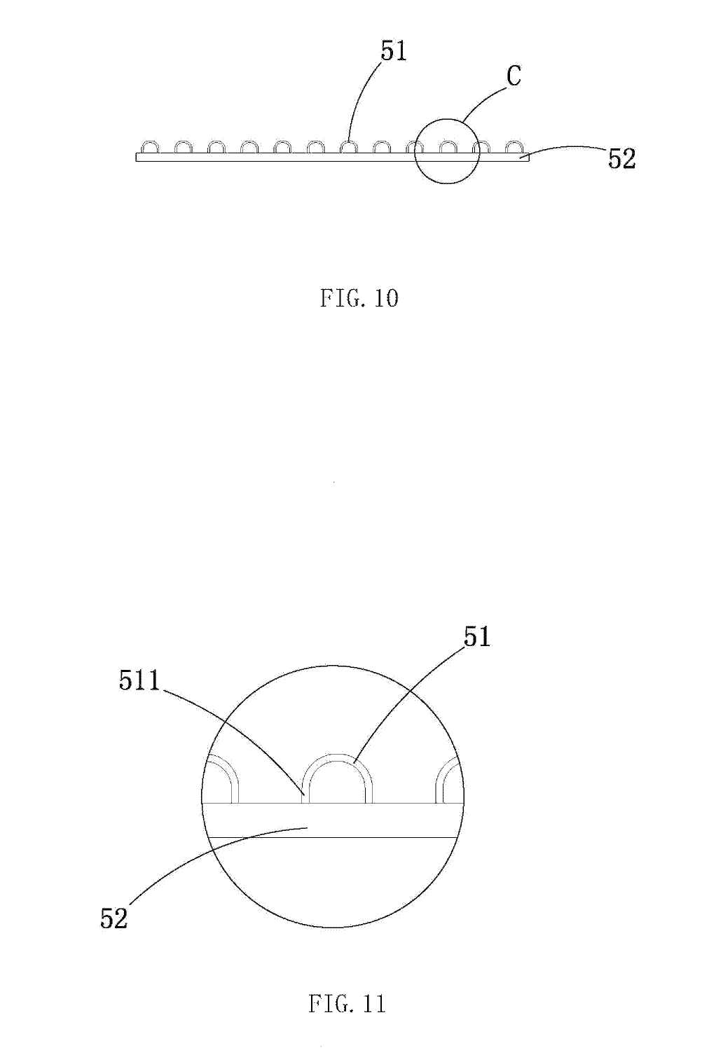

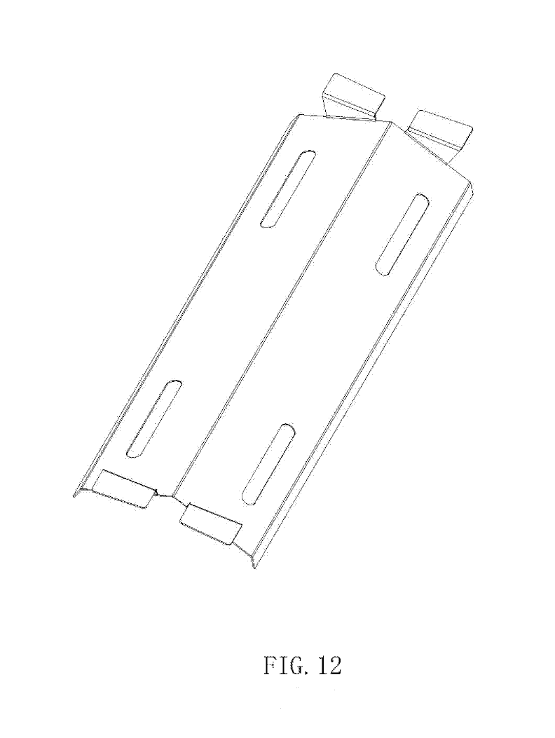

As referred to FIG. 1 to FIG. 11, the embodiment of the barbecue oven provided by the present application comprises a frame body 1, an oven shell 2 arranged on the frame body 1, a burner 3 arranged in the oven shell 2, fire plates 4 arranged above the burner 3 and grilling nets 5 arranged above the fire plates 4; the middle part of the fire plate 4 protrudes, for example, a protrusion 41 may be arranged, each side of the protrusion 41 may be provided with a plurality of upheavals 42, and at the side of the upheavals 42 close to the left and right edges of the fire plates 4 heat emission holes 43 are cut; the grilling net 5 comprises a plurality of grilling strips 51 and a plurality of connecting strips 52, and the grilling strips 51 are connected by the connecting strips 52; the grilling strip 51 is of arc plates, for example, the inverted U-shaped metal sheet with thickness of 0.8-3 mm, 1.5 mm preferable. The distance between the grilling net 5 and the fire plates 4 is 50-120 mm. In this embodiment, 62 mm is preferable. The grilling net 5 with easy processing technique is provided in multiple, and if local damage is found, only the net with local damage needs to be replaced, so saving the cost. First, the arrangement of the upheavals 42 expands the heat dissipation area of the fire plate 4, thereby improving the heat dissipation efficiency of the fire plate 4; the heat emission holes 43 cut on one side of the upheavals 42 close to the right and left edges of the fire plates 4 effectively narrow the temperature difference between the position above the gap between each two adjacent fire plates 4 and the position above the fire plate 4, leading to even heating of food on the grilling net 5 and improved barbecue efficiency. Further, the non-opposite arrangement of the heat emission holes 43 and the grilling net 5 prevents the grease or residues of foods from falling to the position below the fire plates 4; second, the grilling net 5 of the present application, with simple structure and easy processing technique, is formed by arc plates as the grilling strips 51, especially the inverted U-shaped metal sheet, so having a very high thermal efficiency, while reducing the temperature difference between the grilling strips and the gaps between the grilling strips. The grilling net maximizes the thermal efficiency of the present application, makes the food heated more uniformly, has high thermal efficiency and good energy saving, and further prevents the food from being burned if the food in direct contact with the grilling strips 51 and facilitates the grease to fall down and reduce the grease on the grilling strips 51, and finally, as the food is not easy to stick with the grilling strips 51, it is easy to clean.

As referred to FIG. 1 to FIG. 3, in the embodiment of the present application described above, the oven shell 2 comprises a lower shell 21, a first flip top 22 and a second flip top 23 arranged on the lower shell 21, which are respectively articulated with the right and left sides of the lower shell 21, a wind shield 24 which is articulated with the lower shell 21. During the use, after the flip top 22 and the second flip top 23 are opened towards the right and left sides of the lower shell 21, the flip top 22 and the second flip top 23 are horizontal, able to holding articles with light weight such as dishes and seasoning; after being unfolded, the wind shield 24 is surrounded in three sides, having a good wind screening effect and facilitating the operation of barbecue. The oven shell 2 has simple structure and easy operation and is easy for packing up.

As referred to FIG. 4 to FIG. 6, in the embodiment of the present application described above, the upheavals 42 are of symmetric cambered surface with pointed ends. The upheavals 42 in such structure lead to more even heat dissipation and temperature above the fire plates 4 and easy cleaning.

As referred to FIG. 4 to FIG. 6, in the embodiment of the present application described above, the rising height of the upheavals 42 gradually increases from the middle of the fire plates 4 to the edge. Such structure is beneficial for the punch forming of the upheavals 42 and the cutting of the heat emission holes 43, and further to effectively narrow the temperature difference between the middle of the fire plates 4 and the edge of the two sides.

As referred to FIG. 4 to FIG. 6, in the embodiment of the present application described above, the fire plate 4 is formed by punching integratively, with easy processing technique and low production cost.

As referred to FIG. 4 to FIG. 6, in the embodiment of the present application described above, the fire plate 4 is provided with holder parts 44, and the oven shell 2 is provided with a support step (not shown in the figures), and the holder part 44 is matched with the support step. The holder parts 4 at the two ends of the fire plate 4 lean against the support steps at the oven shell 6.

As referred to FIG. 4 to FIG. 6, in the embodiment of the present application described above, the end port of the heat emission holes 43 is in a shape of a bow, with the ratio of height to chord length of 0.2-0.6, and 0.38 preferable in this embodiment. The ratio of the sum of the surface area of the upheaval of one fire plate to the surface area of one fire plate is 0.15-0.7, and 0.25 is preferable in this embodiment. This structure results in more even temperature above the fire plate 1, higher heat dissipation efficiency and no impact on the mechanical strength of the fire plate 1.

As referred to FIG. 4 to FIG. 6, in the embodiment of the present application described above, the fire plate 4 comprises a plate body, the two sides of which bend towards the central line of the plate body, at one side of the central line a first plate body is firmed and at the other side a second plate body is formed, and the angle between the first plate body and the second plate body is 90-137° preferable. The protrusion 41 is formed at the central line.

As referred to FIG. 4 to FIG. 6, in the embodiment of the present application described above, the max height of the upheaval 42 is 5-12 mm, 7 mm preferable in this embodiment.

As referred to FIG. 4 to FIG. 6, in the embodiment of the present application described above, the net distance at the narrowest position between each two adjacent upheavals 42 at the same side of the protrusion 41 is 10-35 mm, 14 mm preferable in this embodiment.

As referred to FIG. 4 to FIG. 6, in the embodiment of the present application described above, the distance between two adjacent upheavals 42 at the two sides of the protrusion 41 is 20-30 mm, 23 mm preferable in this embodiment. The distance between two upheavals 42 refers to the distance of horizontal projections of the pointed ends of the upheavals 42.

As referred to FIG. 4 to FIG. 6, in the embodiment of the present application described above, the length of the fire plate 4 is 350-500 mm, 395 mm preferable in this embodiment; the width of the fire plate 4 is 100-150 mm, 123 mm preferable; and the height of the fire plate 4 is 25-40 mm, 31.3 mm preferable.

As referred to FIG. 7 to FIG. 11, in the embodiment of the present application described above, preferably, an elevated part 511 is arranged at the bottom end of the inverted U-shaped metal sheet. The elevated part 511 is a slat. The height of the elevated part 511 is 1-6 mm, 3 mm preferably. The elevated part 511 is connected with the connecting strip 52. The arrangement of the elevated part 511 further improves the heat gathering efficiency of the grilling strips 51 and then the thermal efficiency of the application. The design of the elevated part 511 also improves the mechanical strength of the grilling strips 51.

As referred to FIG. 7 to FIG. 11, in the embodiment of the present application described above, a plurality of the grilling strips 51 are arranged orderly and in parallel on the connecting strips 52, and the net distance between each two adjacent grilling strips 51 is 10-14 mm, 12 mm preferably. The distance between each two adjacent grilling strips 51 controlled to such a range is not only suitable for the grilling of most foods, but also helpful to improve thermal efficiency and energy conservation.

As referred to FIG. 7 to FIG. 11, in the embodiment of the present application described above, the width of the grilling strip 51 is 5-25 mm, 14.50 mm preferably. The projected width of the grilling strip 51 in such range contributes to improve the thermal efficiency without impact on the mechanical strength of the grilling net 5; and so the upper end face of the grilling strips 51 serves to fry and grill foods without burning foods due to over high temperature.

As referred to FIG. 7 to FIG. 11, in the embodiment of the present application described above, the height of the grilling strip 51 is 3-15 mm, 10.25 mm preferable in this embodiment. The structure is conductive to the heat dissipation from the grilling strips 51, and the part of the side of the grilling strips 51 not in contact with food conducts heat to the gap between the adjacent grilling strips 51 to have foods heated evenly and improve thermal efficiency.

As referred to FIG. 7 to FIG. 11, in the embodiment of the present application described above, the grilling strips 51 are preferably the inverted U-shaped metal sheet. Apart from easy processing, low production cost, good thermal conduction, high mechanical strength and being not easily contaminated by grease so easy to clean, the inverted U-shaped metal sheet has superb heat gathering effect while low cost, which is most important.

As referred to FIG. 7 to FIG. 11, in the embodiment of the present application described above, the grilling strips 51 are formed by punching integratively, with easy processing technique, low production cost and high product precision.

As referred to FIG. 7 to FIG. 11, in the embodiment of the present application described above, the arc radius of the inverted U-shaped metal sheet is 5-10 mm, 6.5 mm preferably in this embodiment; the central angle is 60-270°, 180° preferable.

The table below shows the experimental data of thermal efficiency of the fire plates of this embodiment (as shown in FIG. 4-6) and the prior art (as shown in FIG. 12) in different period of time during the barbecue.

| | Fire plates of the embodiment | | | | | | |
|---|---|---|---|---|---|---|---|
| | No. 1 | No. 2 | No. 3 | No. 4 | No. 5 | No. 6 | |
| | fire | fire | fire | fire | fire | fire | |
| | plate | plate | plate | plate | plate | plate | Average |
| 1 min | 156.1 | 112.9 | 98.9 | 109.7 | 130.8 | 115.3 | 120.6 |
| 3 min | 274.5 | 240.6 | 218.3 | 254 | 256.7 | 227.2 | 245.2 |
| 5 min | 340.7 | 338.4 | 259.5 | 314.3 | 374.4 | 297.2 | 320.8 |
| 10 min | 365.9 | 355.7 | 340.3 | 391.8 | 395.3 | 307 | 359.3 |
| 15 min | 355.8 | 336.5 | 364.8 | 424.6 | 379.9 | 305.9 | 361.3 |

| | Fire plates of prior art | | | | | | |
|---|---|---|---|---|---|---|---|
| | No. 1 | No. 2 | No. 3 | No. 4 | No. 5 | No. 6 | |
| | fire | fire | fire | fire | fire | fire | |
| | plate | plate | plate | plate | plate | plate | Average |
| 1 min | 143.1 | 114.6 | 76.2 | 131.7 | 100.7 | 124.1 | 115.1 |
| 3 min | 253 | 226.5 | 174.6 | 242.7 | 203.9 | 223 | 220.6 |
| 5 min | 329 | 308.9 | 258.2 | 280.3 | 302.1 | 332.5 | 301.8 |
| 10 min | 317.6 | 350.5 | 288.9 | 358.9 | 350.9 | 308.2 | 329.2 |
| 15 min | 334.1 | 354.7 | 296.9 | 367.6 | 380.3 | 274.9 | 334.8 |

While the embodiments of the present application have been shown and described, it will he understood by those skilled in the art that changes may he made to these embodiments as long as such changes will not deviate from the principles and spirits of the application, and that the scope of the application is defined by the appended claims and the equivalents.

1. A barbecue oven, comprising a frame body, an oven shell arranged on the frame body, a burner arranged in the oven shell, fire plates arranged above the burner and nets arranged above the fire plates, wherein a protrusion is arranged at the middle part of said fire plates and each side of said protrusion is provided with a plurality of upheavals, and at the side of said upheavals close to the left and right edges of said fire plates, heat emission holes are cut; said grilling net comprises a plurality of grilling strips which are inverted U-shaped metal sheets and a plurality of connecting strips; and said grilling strips are connected by said connecting strips.

2. The barbecue oven according to claim 1, wherein the distance between said grilling net and said fire plates is 50-120 mm.

3. The barbecue oven according to claim 1 or claim 2, wherein said upheavals are in the shape of symmetric cambered surface with pointed ends.

4. The barbecue oven according to claim 1 or claim 2, wherein the rising height of said upheavals gradually increases from the middle of the fire plates to the edge.

5. The barbecue oven according to claim 1 or claim 2, wherein the max height of said upheavals is 5-12 mm.

6. The barbecue oven according to claim 1 or claim 2, wherein the net distance at the narrowest part between each two adjacent upheavals at the same side of said protrusion is 10-35 mm.

7. The barbecue oven according to claim 1 or claim 2, wherein an elevated part is arranged at the bottom end of said inverted U-shaped metal sheet and is connected with said connecting strips.

8. The barbecue oven according to claim 7, wherein the height of said elevated part is 1-6 mm.

9. The barbecue oven according to claim 1 or claim 2, wherein said grilling strips are arranged orderly and in parallel on said connecting strips and the net distance between each two adjacent grilling strips is 10-14 mm.

10. The barbecue oven according to claim 1 or claim 2, wherein the width of said grilling strips is 5-25 mm and the height of said grilling strips is 3-15 mm.
